(19) United States
(12) Patent Application Publication
(10) Pub. No.: US 2024/0163022 A1
(43) Pub. Date: May 16, 2024

(54) DYNAMIC TRANSMISSION PARAMETER VALUES FOR RETRANSMISSIONS

(71) Applicant: Sony Group Corporation, Tokyo (JP)

(72) Inventors: Busuki PRIYANTO, Lund (SE); Rui NUNES, Lund (SE); Shin Horng WONG, Basingstoke (GB); Anders BERGGREN, Lund (SE); Ola CEDELL, Malmö (SE); Adnan PRLJA, Malmö (SE); Jacob WAEDUEMASOR, Lund (SE)

(21) Appl. No.: 18/282,751

(22) PCT Filed: Mar. 30, 2022
(86) PCT No.: PCT/EP2022/058439

§ 371 Date: Sep. 18, 2023

(30) Foreign Application Priority Data
Mar. 31, 2021 (SE) 2150406-3

(51) Int. Cl. H04L 1/1812; H04L 1/00

(52) U.S. Cl. CPC H04L 1/1819; H04L 1/0003; H04L 1/0025

(57) ABSTRACT

At least partly different values are used for a transmission parameter—e.g., modulation and coding or repetition count—between an initial transmission and a retransmission.

### TECHNICAL FIELD

Various examples of the disclosure are broadly concerned with initial transmissions of data and retransmissions of the data. The initial transmissions use a first value of a transmission parameter, while at least one of the retransmissions uses a second value of the transmission parameter.

### BACKGROUND

Wireless communications, specifically cellular wireless communication, is evolving. The Third Generation Partnership Projection (3GPP) 5G New Radio (NR) technology is expected to support Extended Reality (XR) applications, such as Virtual Reality (VR), Augmented Reality (AR), and Cloud gaming (CG). Data services supporting such applications typically require high data rates (e.g., video streaming), multi-streams, and low packet delay. I.e., the performance requirements of the data services are challenging.

The existing 5G NR protocol is designed to support enhanced Mobile Broadband (eMBB), Ultra-Reliable Low Latency Communication (URLLC), and massive Machine

Type Communications (mMTC). eMBB can deliver high data rates with best effort, i.e., data can be retransmitted several times with the cost of additional delay. URLLC can provide ultra-reliable and low-latency transmission designed for small data packet (e.g., sensors data).

### SUMMARY

There is a need to provide data services with high data rates and with reasonable reliability.

This need is met by the features of the independent claims. The features of the dependent claims define embodiments.

A method of operating a wireless communication device is provided. The wireless communication device communicates data with a node of a communications network. The method includes participating in an initial transmission of multiple code block groups of a transport block using a first value of a transmission parameter. The multiple code block groups respectively include a part of the data. The method also includes participating in one or more retransmissions of at least one of the multiple code block groups using one or more second values of the transmission parameter. The first value is different than at least one of the one or more second values.

A computer program or a computer-program product or a computer-readable storage medium includes program code. The program code can be loaded and executed by at least one processor. Upon loading and executing the program code, the at least one processor performs a method of operating a wireless communication device. The wireless communication device communicates data with a node of a communications network. The method includes participating in an initial transmission of multiple code block groups of a transport block using a first value of a transmission parameter. The multiple code block groups respectively include a part of the data. The method also includes participating in one or more retransmissions of at least one of the multiple code block groups using one or more second values of the transmission parameter. The first value is different than at least one of the one or more second values.

A wireless communication device for communicating data with a node of a communications network is provided. The wireless communication device includes a control circuitry. The control circuitry is configured to participate in an initial transmission of multiple code block groups of a transport block using a first value of a transmission parameter. The multiple code block groups respectively include a part of the data. The control circuitry is further configured to participate in one or more retransmissions of at least one of the multiple code block groups using one or more second values of the transmission parameter. The first value is different than at least one of the one or more second values.

A method of operating a node of a communications network is provided. The node communicates data with a wireless communication device. The method includes participating in an initial transmission of multiple code block groups of a transport block.

The initial transmission uses a first value of a transmission parameter. The multiple code block groups respectively include a part of the data. The method further includes participating in one or more retransmissions of at least one of the multiple code block groups using a second value of the transmission parameter. The first value is different than at least one of the one or more second values.

A computer program or a computer-program product or a computer-readable storage medium includes program code. The program code can be loaded and executed by at least one processor. Upon loading and executing the program code, the at least one processor performs a method of operating a node. The node communicates data with a wireless communication device. The method includes participating in an initial transmission of multiple code block groups of a transport block. The initial transmission uses a first value of a transmission parameter. The multiple code block groups respectively include a part of the data. The method further includes participating in one or more retransmissions of at least one of the multiple code block groups using a second value of the transmission parameter. The first value is different than at least one of the one or more second values.

A node of a communications network is provided. The node is for communicating data with a wireless communication device. The node includes a control circuitry. The control circuitry is configured to participate in an initial transmission of multiple code block groups of a transport block using a first value of a transmission parameter. The multiple code block groups respectively include a part of the data. The control circuitry is further configured to participate in one or more retransmissions of at least one of the multiple code block groups using one or more second values of the transmission parameter.

The first value is different than at least one of the one or more second values.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular NW and a UE connected to the cellular NW according to various examples.

FIG. 2 is a signaling diagram illustrating a dynamic link adaptation protocol according to various examples.

FIG. 3 is a signaling diagram illustrating a retransmission protocol according to various examples.

FIG. 4 schematically illustrates a correlation between delay and retransmissions of the retransmission protocol according to various examples.

FIG. 5 schematically illustrates a transport block and multiple code block groups according to various examples.

FIG. 6 schematically illustrates retransmission of multiple code block groups according to various examples.

FIG. 7 schematically illustrates retransmission of multiple code block groups according to various examples.

FIG. 8 schematically illustrates retransmission of multiple code block groups according to various examples.

FIG. 9 schematically illustrates retransmission of multiple code block groups according to various examples.

FIG. 10 schematically illustrates time-frequency resources allocated to an initial transmission and multiple retransmissions according to various examples.

FIG. 11 schematically illustrates a wireless communication device according to various examples.

FIG. 12 schematically illustrates a base station according to various examples.

FIG. 13 is a flowchart of a method according to various examples.

FIG. 14 is a flowchart of a method according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between communication nodes (CNs; hereinafter, simply node). In some examples, the wireless communication system can be implemented by a wireless communication network, e.g., a radio-access network (RAN) of a 3GPP-specified cellular network (NW). In such case, the nodes can be implemented by an access node such as a base station (BS) of the RAN and by wireless communication devices (also referred to as user equipment, UE).

A communication between a BS and a UE can include communicating data from the BS to the UE (downlink, DL) and from the UE to the BS (uplink, UL). Also, sidelink (SL) communication between two UEs, or generally two peers, would be possible.

Hereinafter, various aspects will be described with respect to DL communication. Similar techniques may be readily applied for UL communication or SL communication.

Various techniques are based on the finding that some applications, such as high quality and real time video streaming applications, require data services with high data rates and low packet delay. TAB. 1 summarizes example requirements for data services that support certain demanding applications.

TABLE 1
Example performance requirements for data services
supporting VR/AR and CG applications, respectively.

| Appli- | Bitrate for downlink | Air interface packet delay budget |
|---|---|---|
| cation | video streaming | (PDB) for video streaming |
| VR/AR | 30, 45 Mbps @ 60 fps | 10 ms (mandatory), 5, 20 ms |
| | (mandatory), 60 Mbps @ | (optional) |
| | 60 fps (optional) | |
| CG | 8, 30 Mbps @ 60 fps | 15 ms (mandatory), 10, 30 ms |
| | (mandatory), 45 Mbps @ | (optional) |
| | 60 fps (optional) | |

Hereinafter, techniques will be described which help to meet such challenging performance requirements as illustrated in TAB. 1.

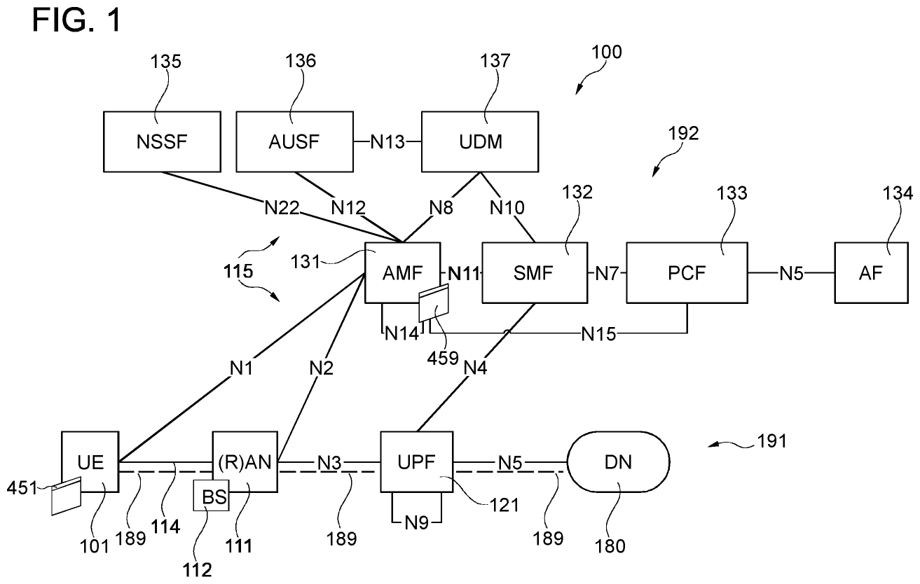

FIG. 1 schematically illustrates a cellular NW 100. The example of FIG. 1 illustrates the cellular NW 100 according to the 3GPP 5G architecture. Details of the 3GPP 5G architecture are described in 3GPP TS 23.501, v16.7.0 (2020 December). While FIG. 1 and further parts of the following description illustrate techniques in the 3GPP 5G framework of a cellular NW, similar techniques may be readily applied to other communication protocols. Examples include 3GPP LTE 4G—e.g., in the MTC or NB-IoT framework—and even non-cellular wireless systems, e.g., an IEEE Wi-Fi technology.

In the scenario of FIG. 1, a UE 101 is connectable to the cellular NW 100. For example, the UE 101 may be one of the following: a cellular phone; a smart phone; an IoT device; a MTC device; a sensor; an actuator; etc. The UE 101 has a respective identity 451, e.g., a subscriber identity.

The UE 101 is connectable to a core NW (CN) 115 of the cellular NW 100 via a RAN 111, typically formed by one or more BSs 112 (only a single BS 112 is illustrated in FIG. 1 for sake of simplicity). A radio link 114 is established between the RAN 111—specifically between one or more of the BSs 112 of the RAN 111—and the UE 101. To perform channel sounding and/or enable the UE 101 to maintain synchronization, it is possible that the BS 112 transmits reference signals (RSs). A dynamic link adaptation protocol may operate based on the RSs.

The radio link 114 implements a time-frequency resource grid. Typically, OFDM is used: here, a carrier includes multiple subcarriers. The subcarriers (in frequency domain) and the symbols (in time domain) then define time-frequency resource elements of the time-frequency resource grid. Thereby, a protocol time base is defined, e.g., by the duration of frames and subframes including multiple symbols and the start and stop positions of the frames and subframes. Different time-frequency resource elements can be allocated to different logical channels of the radio link 114. Examples include: Physical DL Shared Channel (PDSCH); Physical DL Control Channel (PDCCH); Physical Uplink Shared Channel (PUSCH); Physical Uplink Control Channel (PUCCH); channels for random access; etc. For instance, time-frequency resources on the PDSCH and PUSCH can be scheduled by using a Downlink Control Information (DCI) communicated on the PDCCH.

In some scenarios, the radio link 114 is implemented on one or more bandwidth parts (BWPs). A BWP is generally defined by a frequency range that is a subset of the entire bandwidth of a carrier. A BWP can be implemented by a contiguous set of time-frequency resources that are selected from a contiguous subset of the common time-frequency resources for a given numerology on a given carrier. BWPs are described in 3GPP Technical Specification (TS) 38.211, Version 16.4.0, 2021 Jan. 8. I.e., different BWPs share the same carrier. In reference implementations, only a single BWP can be active at a time (active BWP). Various techniques are available for switching between BWPs. A specific BWP can be activated by Bandwidth part indicator in DCI Format 0_1 (a UL Grant) and DCI Format 0_1 (a DL Schedule). An inactivity timer can be used. RRC signaling can be used.

The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data NW 180, e.g., the Internet or a Local Area NW. Application data can be communicated between the UE 101 and one or more servers on the data NW 180.

The cellular NW 100 also includes a mobility-control node, here implemented by an

Access and Mobility Management Function (AMF) 131 and a Session Management Function (SMF) 132.

The cellular NW 100 further includes a Policy Control Function (PCF) 133; an Application Function (AF) 134; a NW Slice Selection Function (NSSF) 134; an Authentication Server Function (AUSF) 136; and a Unified Data Management (UDM) 137. FIG. 1 also illustrates the protocol reference points N1-N22 between these nodes.

The AMF 131 provides one or more of the following functionalities: connection management sometimes also referred to as registration management; NAS termination for communication between the CN 115 and the UE 101; connection management; reachability management; mobility management; connection authentication; and connection authorization. For example, the AMF 131 controls CN-initiated paging of the UE 101, if the respective UE 101 operates in the idle mode.

A data connection 189 is established by the SMF 132 if the respective UE 101 operates in a connected mode. The data connection 189 is characterized by UE subscription information hosted by the UDM 137. To keep track of the current mode of the UE 101, the AMF 131 sets the UE 101 to CM-CONNECTED or CM-IDLE. During CM-CONNECTED, a non-access stratum (NAS) connection is maintained between the UE 101 and the AMF 131. The NAS connection implements an example of a mobility control connection. The NAS connection may be set up in response to paging of the UE 101.

The SMF 132 provides one or more of the following functionalities: session management including session establishment, modify and release, including bearers set up of

UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 and the RAN 111 and on to the UP 191 of the CN 115 and towards the DN 180. For example, a connection with the Internet or another packet data NW can be established. To establish the data connection 189, i.e., to connect to the cellular NW 100, it is possible that the respective UE 101 performs an RA procedure, e.g., in response to reception of paging signals. This establishes at least a RAN-part of the data connection 189. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the OSI model.

The data connection 189 can support one or more data services. I.e., application data of an application associated with such a data service can be communicated on the data connection 189. Example applications have been discussed in connection with TAB. 1.

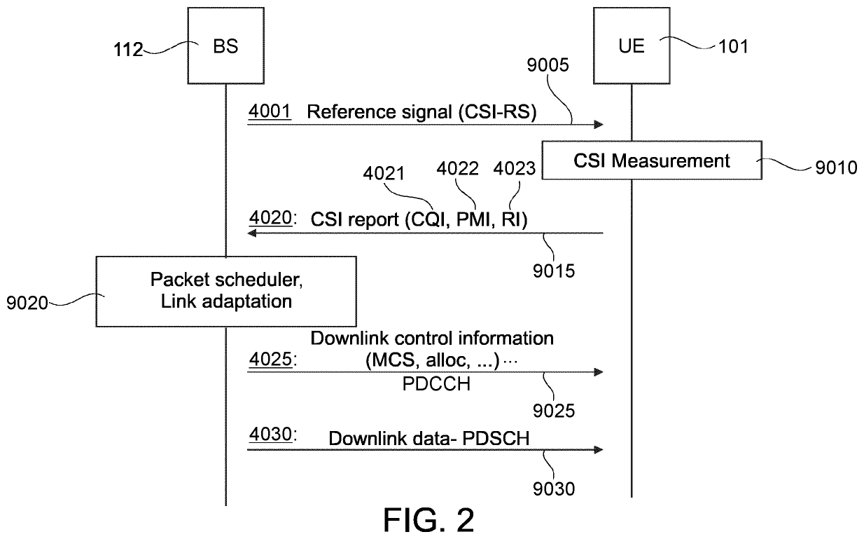

Further details with respect to such communication of application data are described in connection with FIG. 2.

FIG. 2 schematically illustrates aspects with respect to communicating application data 4030. For illustration, it is assumed that the application data includes a video frame.

A video frame—defined by the respective application—is typically divided into multiple Internet Protocol packets and further divided into multiple transport blocks (TBs) defined by a respective transport block size. Furthermore, the modulation and coding scheme (MCS) of a TB is chosen based on the radio environment and the configured error rate target (e.g., Block Error Rate (BLER)), to maximize the throughput. The MCS selection is part of a dynamic link adaptation protocol.

Generally speaking, the MCS defines the modulation that is used, e.g., Phase Shift Keying, Binary Phase Shift Keying, quadrature phase shift keying, Differential QPSK, quadrature amplitude modulation (QAM), etc.

The more complex the modulation, the higher the data rate. More complex modulations require better radio channel conditions such as less interference and a good line of sight.

The MCS also defines the coding ratio, i.e., a fraction of the total data stream that is actually being used to transmit usable data. The rest is overhead.

FIG. 2 is a signalling diagram illustrating aspects with respect to the dynamic link adaption protocol. Aspects of the dynamic link adaptation protocol illustrated in FIG. 2 are specified according to 3GPP TSs (e.g., TS 38.214 v16.20 (2020 June)).

The dynamic link adaptation protocol can be described as follows. The UE performs channel (radio link condition) measurements—also referred to as Channel State Information (CSI) measurements—that include signal to noise and interference ratio (SINR) estimation. More generally, the UE monitors, at 9010, for RSs 4001 transmitted by the BS at 9005.

Based on a receive property of the RSs, the UE can determine the condition of the radio link. Then, the UE puts together based on a certain ruleset (compiles) a channel quality report message. The channel quality report message is indicative of an MCS that could meet certain performance requirements of a data service, as estimated based on the RSs. The channel quality report message can include a value that is indicative of the channel quality. For sake of simplicity, this value is hereinafter referred to as channel quality indicator (CQI). More specifically, the CQI can be indicative of an MCS for communicating data. The CQI can suggest an MCS to be used by the BS. More specifically, the CQI can indicate the highest MCS at which a certain target error rate is not exceeded. The CQI—according to reference techniques—is determined using a reference to a target error rate, specifically the Block Error Rate (BLER) target of the measured SINR. The ruleset typically specifies the BLER target as 10%. However, for data services supporting URLLC, the BLER target is 0.0001% to improve reliability. High and low BLER targets will result in higher and lower CQI index, respectively.

Apart from the CQI, the UE can also calculate and identify the best precoding matrix index (PMI) and Rank Indication (RI). The UE provides a channel quality report message 4020 (including CQI 4021, PMI 4022, and RI 4023) to the BS 112, at 9015.

The channel quality report message could be transmitted on the PUCCH or the PUSCH. It can be transmitted periodically or aperiodically, i.e., in response to a respective request from the BS 112.

The BS 112 can then—at 9020—assign the MCS for the application data 4030 of the data service based on the reported CQI 4021. Furthermore, The BS 112 can then—at 9020—assign the PMI and RI for the application data 4030 transmission of the data service based on the reported PMI 4022, RI 4023, respectively. Higher CQI 4021 corresponds to higher MCS. Hence, the throughput is higher in comparison with the data transmission with lower MCS.

The selected MCS for the TB and other parameters are conveyed by BS 112 to UE 30 101 in a DCI 4025 communicated on the PDCCH at 9025. The TB carrying the application data 4030 is transmitted in PDSCH at 9030.

Even when accurately setting the MCS based on the transmission of RSs—e.g., as part of the dynamic link adaptation protocol, as described above—it can happen that the transmission of the application data 4030 fails, at box 9030. To detect transmission failures, checksums can be used. For example, the TB can include a checksum. The checksum is determined based on the remaining bits of the TB, e.g., using a hashing value. Forward error correction can be used. Where a corrupted TB is detected, a retransmission of the data can be implemented.

Sometimes, the TB can be even further structured into the code block groups (CBGs) and each CBG can include a respective checksum. This helps to limit the retransmissions to fractions of the initial TB, i.e., CBG-based retransmissions.

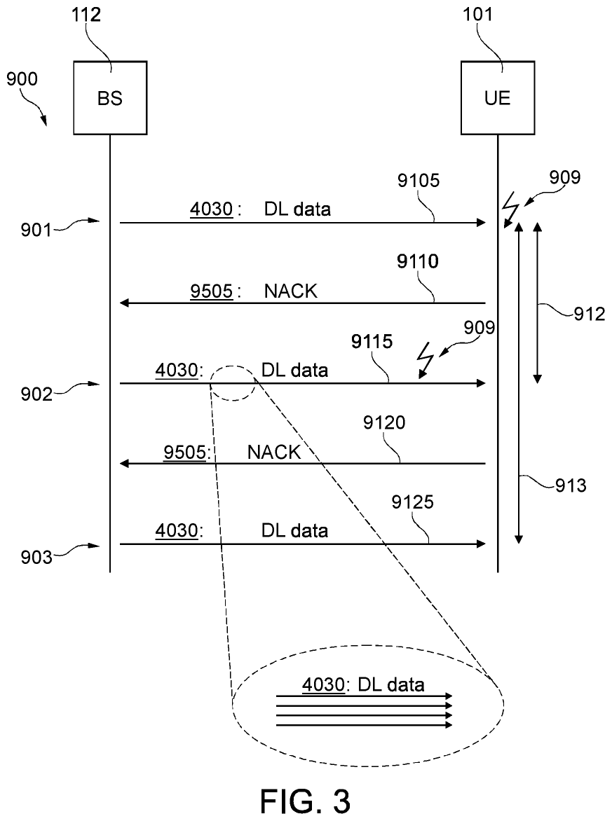

A retransmission protocol—e.g., an Automatic Repeat Request (ARQ) protocol—can be used in order to trigger one or more retransmissions in response to transmission failures. Aspects with respect to a retransmission protocol are illustrated in connection with FIG. 3.

FIG. 3 is a signaling diagram of communication between the BS 112 and the UE 101. FIG. 3 illustrates aspects with respect to a retransmission protocol 900 for protecting application data 4030 communicated from the BS 112 to the UE 101.

As a general rule—while FIG. 3 illustrates aspects with respect to the retransmission protocol 900 in the context of DL application data 4030—a retransmission protocol can also be used in order to protect UL data or SL data.

At 9105, the application data 4030 is transmitted by the BS 112. One or more TB carry the application data 4030. This corresponds to an initial transmission 901 of a given data, i.e., the first time a certain data element is transmitted. For example, 9105 could correspond to 9030 (cf. FIG. 2).

A transmission failure 909 occurs. The respective TB including the DL data 4030 does not arrive at the UE 101 or only arrives corrupted or at least partly corrupted. For instance, one or more CBGs of the TB could be corrupted.

Accordingly, the UE 101 transmits, at 9110, a negative acknowledgment (NACK) 9505 that is indicative of the transmission failure 909 that has occurred. For instance, a bitmap could indicate all corrupted CBGs.

Hence, the retransmission protocol 900 triggers a retransmission 902 at least of the corrupted parts of the DL data 4030—e.g., one or more corrupted CBGs could be retransmitted, or it would also be possible to retransmit the entire TB—at 9115.

Sometimes, a different redundancy version of the retransmitted at least parts of the application data 4030 may be transmitted; here, stronger forward error protection can be employed.

In the illustrated scenario, again a transmission failure 909 occurs; and, accordingly, the UE 101 transmits, at 9120, a NACK 9505 negatively acknowledging at least parts of the application data 4030 that has been included in the retransmission 902.

The BS 112, at 9125, implements a further retransmission 903 of at least parts of the application data 4030. As illustrated, the at least parts of the application data 4030 of the retransmission 903 arrive uncorrupted at the UE 101.

The retransmission 902 is a first order retransmission; the retransmission 903 is a second order retransmission. As a general rule, the retransmission protocol can be configured to implement a predefined count of retransmissions.

Sometimes, the initial transmission is referred to as first transmission, the first retransmission is referred to as second transmission, the second retransmission is referred to as third transmission, and so one.

FIG. 3 also illustrates aspects with respect to repetitions of the data. Specifically, the inset of FIG. 3 illustrates for the retransmission 902 that at least parts of the application data 4030 can be transmitted multiple times. This is referred to transmission repetitions. The transmission repetitions different from retransmissions in that they are proactively triggered by the BS 112, i.e., not triggered by a NACK. The transmission repetitions are sometimes also referred to as a repetition burst for coverage enhancement (CE). The count of repetitions is a transmission parameter that can be set accordingly. Using multiple repetitions increases the reliability.

As a general rule, according to various examples disclosed herein, multiple repetitions of data can be encoded according to the same redundancy version or different redundancy versions. By using different redundancy versions, different sets of coded bits representing the same set of information bits can be generated.

Using a higher count of repetitions may increase the spectrum allocation. I.e., more time-frequency resources are required to accommodate for the multiple repetitions. On the other hand, the likelihood of a transmission failure 909 is reduced.

Using repetitions is only one means to reduce the likelihood of a transmission failure 909. The values of other transmission parameters—beyond the count/number of repetitions—can be set so as to robustly protect the data. To give an example, a further transmission parameter whose value can be set accordingly is the MCS. Here, lower MCS can protect the data; on the other hand, more time-frequency resources are required.

Various examples are based on the finding that the increased spectrum allocation for higher protection of the data needs to be put in relation with the increased delay due to the retransmissions that otherwise become more likely.

As will be appreciated from FIG. 3, the retransmission 902, 903 introduce respective delays 912, 913.

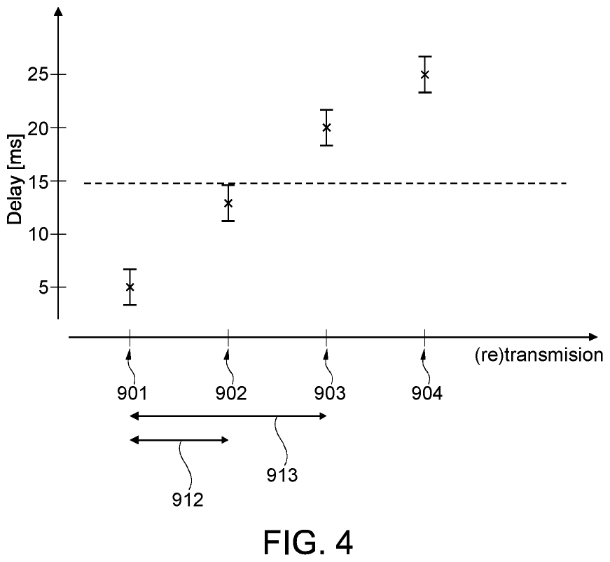

In legacy 3GPP Long Term Evolution (LTE) protocol and NR protocol, a data service uses a BLER target of 10% (High BLER target). A specific use-case in the 3GPP NR protocol, URLLC, uses a BLER target of 0.0001% (low BLER target) with the main motivation to provide ultra-reliability data transmission. Higher BLER target results in the selection of higher MCS. Hence, it maximizes the instantaneous throughput. High throughput is typically needed for video streaming application (particularly with high quality 4K or 8K video resolution). However, it may increase the number of transmission failures 909 due to possible temporary bad radio link condition (e.g., UE sudden movement, blockage). The transmission failures 909 trigger retransmissions, leading to increasing packet delay. The total delay introduced by retransmission are contributed by the airtime of packet retransmission, TX buffering delay, RX packet re-ordering delay (RLC packets within a retransmitted TBs will likely be delivered to PDCP out of order; reordering at PDCP will cause additional delay on adjacent packets). The impact of packet delay due to retransmission is shown in FIG. 4.

FIG. 4 schematically illustrates an empirical dependency of the overall delay of application data of a data service due for the initial transmission 901 and subsequent retransmissions 902-904 of a retransmission protocol. As illustrated in FIG. 4, the delay increases for a larger count of retransmissions.

Various techniques are based on the finding that high packet delay should be avoided for video streaming application because it may disrupt the service or reduce the user experience quality. Recently, 3GPP has approved a study item on XR evaluations, see 3GPP RP-201145. XR includes these applications: Virtual reality (VR), Augmented Reality (AR) and Cloud gaming (CG). These are applications which require high data rate streaming with low packet delay.

Hereinafter, techniques are described which enable both high data rates, as well as low packet delay.

According to various examples, it is possible to reduce the delay in delivery of application data, by improving the reliability of retransmissions of the application data. Various techniques are based on the finding that delay in the delivery of data is typically due to the retransmissions. For example, according to the 3GPP NR protocol, a total count of four retransmissions is supported in order to improve the reliability in the delivery of the data at the cost of a long delay. It has been found that for typical configurations of the data service, a single retransmission is sufficient to meet the delay budget associated with the requirements of various data services, such as virtual reality. The respective threshold delay is illustrated by the dashed line in FIG. 4.

In order to improve the reliability of the delivery of the data, the reliability of the retransmissions can be increased. For example, in reference implementations, it is possible to reduce the MCS of retransmissions; this improves the reliability, however, a reduction of the modulation and coding scheme also reduces the data rate. Accordingly, the BS requires more time-frequency resources to maintain the data rate and subsequent retransmissions.

According to various examples, it is possible to change the value of a transmission parameter between the initial transmission and one or more retransmissions. For example, it would be possible to change the modulation and coding scheme between the initial transmission and at least one of the retransmissions. Alternatively or additionally, it would also be possible to change to repetition count between the initial transmission and at least one of the retransmissions.

More specifically, it would be possible to implement partial retransmissions on CBG level using different values for the transmission parameter. As explained above, for large TB sizes, the TB can be divided into multiple CBGs where each CBG has its own checksum. Thereby, the retransmissions can include one or more CBGs that failed the checksum check rather than the entire TB.

Accordingly, the UE could participate in the initial transmission of multiple CBGs of a TB using a first value of a transmission parameter. The multiple CBGs can respectively include a part of the application data and a respective error checksum. Then, the UE can participate in one or more retransmissions of at least one CBG of the multiple CBGs using a second value of the transmission parameter. The first value can be different than at least one of the one or more second values used for the one or more retransmissions.

As an example, the transmission parameter for which the value is changed between the initial transmission and the at least one of the one or more retransmissions can include the repetition count (cf. inset of FIG. 3). Specifically, the repetition count can be defined with respect to repetitions of CBGs, i.e., a repetition count of “4” would define a four-time repetition of a given CBG.

In a further example, the transmission parameter for which the value is changed between the initial transmission and the at least one of the one or more retransmissions can include the count of redundancy versions for multiple repetitions. For instance, in the initial transmission, a single redundancy version of data may be transmitted. For instance, a code block group code block group may be transmitted that includes information bit encoded according to a certain redundancy version; it would be possible that the code block group is transmitted multiple times, i.e., repeated at a certain repetition count. Here, the count of redundancy versions is “1”. Then, for the at least one retransmission, the count of redundancy versions can be larger than “1”. For instance, a certain code block group can be retransmitted multiple times, i.e., multiple repetitions of the code block group can be included in the at least one retransmission. These multiple repetitions per retransmission can use multiple redundancy versions. Thus, the count of redundancy versions for a retransmission, e.g., retransmission of first order, can be “2” or “3”, etc.

In a further example, the transmission parameter for which the values change between the initial transmission and the at least one of the one or more retransmissions can include the MCS of the respective CBG.

For example, the value of the transmission parameter may be changed between the initial transmission in the first retransmission. In other examples, it would also be possible that the first transmission uses the same value of the transmission parameter as the initial transmission; then the value may be changed between the first retransmission and the second retransmission. In other examples, the value can be changed, both, between the initial transmission in the first retransmission, as well as between the first retransmission and the second retransmission. These are only examples. As a general rule, the value can be flexibly changed between the initial transmission and at least one of the one or more retransmissions.

FIG. 5 schematically illustrates aspects with respect to a TB 201. The TB includes multiple CBGs 211-214. Each CBG includes application data. For instance, different CBGs 211-214 can carry different pieces of a higher-layer packets such as an IP packet. Each CBG 211-214 includes a respective error checksum 221-224. The retransmission protocol 900 can determine transmission failures 909 based on the checksums 221-224. I.e., can be determined that, e.g., the CBG 211 has been delivered uncorrupted; while the CBG 212 has been delivered corrupted, i.e., a transmission failure 909 occurred. Also, the TB 201 includes a respective checksum 205.

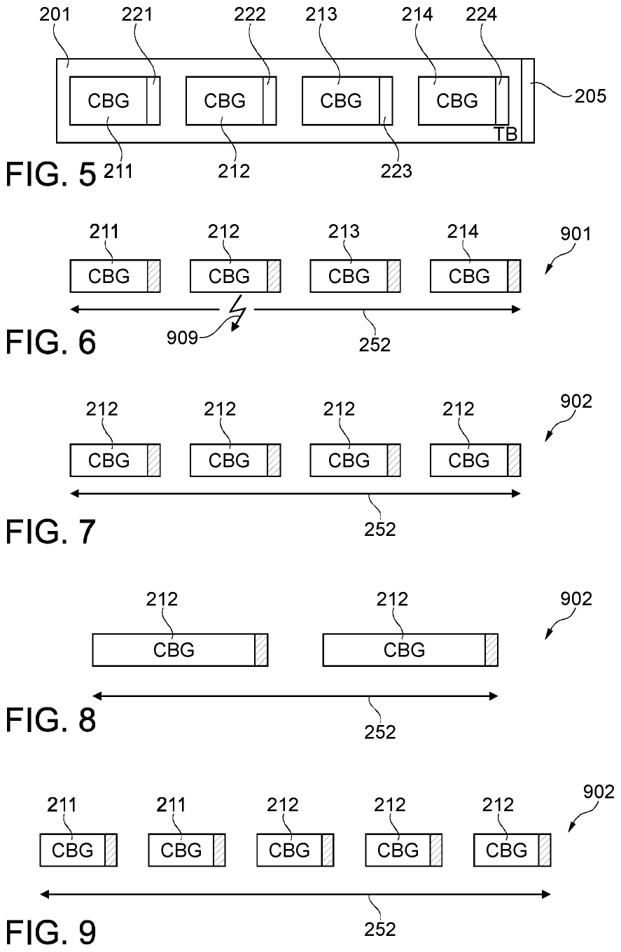

FIG. 6 schematically illustrates aspects with respect to a retransmission protocol opersting with respect to the CBGs 211-214. As illustrated in FIG. 6, initially, each 1 of the CBGs 211-214 is transmitted as part of the initial transmission 901. Then, a transmission failure 909 occurs for the CBG 212; while the CBGs 211, 213, 214 arrive uncorrupted. Accordingly, a retransmission 902 is implemented which includes the CBG 212, only.

One example implementation of the retransmission 902 is illustrated in FIG. 7. According to FIG. 7, the value of the repetition count is set to “4” (instead of “1” as for the initial transmission 901 of FIG. 6). The value of the MCS does not change if compared to the initial transmission 901.

As a general rule, the multiple repetitions of the code block group 212 of the retransmission 902 may be encoded according to the identical redundancy version (RV) or different redundancy versions. The count of RVs per retransmission may change along with the retransmission order. For instance, the first order retransmission may use two different RVs for encoding the same data; the second order retransmission may use four different RVs for encoding that same data, etc. A further example implementation of the retransmission 902 is illustrated in FIG. 8. Here, both, the value of the repetition count is changed if compared to the initial transmission 901, as well as the value of the MCS. Specifically, as illustrated, the value of the MCS is lowered, so that the size of each CBG 212 increases. The repetition count is set to the value “2”.

As will be appreciated from the above, the retransmissions 902 include multiple repetitions of CBGs. I.e., CBGs subject to a transmission failure may be retransmitted multiple times. This recognizes that those CBGs that pass the checksum check are not retransmitted and so time-frequency resources initially allocated to retransmissions of such CBGs that have in fact arrived at the destination node uncorrupted can be used for retransmissions of CBGs that have failed the checksum check.

As a general rule, it is possible that different CBGs are retransmitted using different repetition counts. Such a scenario is illustrated in FIG. 9. FIG. 9 illustrates a scenario of the retransmission 902 based on the initial transmission 901 of FIG. 6, however under the assumption the transmission failures 909 occurred for, both, the CBG 211, as well as the CBG 212. As illustrated, the retransmission 902 includes the CBG 211, as well as the CBG 212; the value of repetition count of the CBG 211 (“2”) is different than the value of the repetition count of the CBG 212 (“3”).

As a general rule, where a retransmission includes multiple CBGs, different ones of the multiple CBGs can be retransmitted using different values of the transmission parameter.

As a general rule, there are various options available for indicating the value of the transmission parameter to be used in one or more retransmissions. For instance, it would be possible that an explicit or implicit indication is obtained from the base station. The explicit indication can include an indicator—e.g., encoded according to a predefined codebook—that specifies the respective value, e.g., the value of the count of repetitions or the value of the MCS.

For example, a higher-layer control message—e.g., an RRC control message—could be received that includes an indicator that is explicitly indicative of the value of the repetition count to be used for, e.g., the first retransmission, the second retransmission, etc.

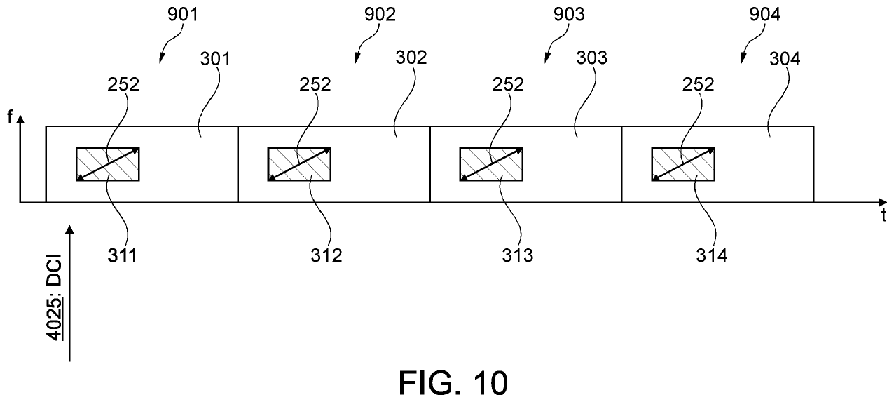

Also, an implicit indication would be possible. For instance, it would be possible to receive a DCI that include scheduling information for the initial transmission, as well as the retransmissions. The scheduling information can include time-frequency resources allocated based on a respective TB 201. In any case, the scheduling information is provided at a point-in-time at which the actual need for a retransmission, let alone the amount of CBGs to be retransmitted is not yet known, i.e., prior to the initial transmission. This is illustrated in connection with FIG. 10.

FIG. 10 schematically illustrates aspects with respect to time-frequency resources 311-314 allocated on the radio link 114. Time-frequency resources can be allocated, e.g., as physical resource blocks. Time-frequency resources are defined in the respective time-frequency resource grid, as illustrated in FIG. 10.

As illustrated, multiple sets of the time-frequency resources 311-314 are allocated to the initial transmission 901, and the retransmissions 902-904, respectively. A respective DCI 4025 is communicated. The different sets of the time-frequency resources 311-314 are included in different frames 301-304 of the respective transmission protocol implemented on the radio link 114. This is an example; in some examples, it would also be possible that sets of time-frequency resources allocated to different (re-)transmissions are allocated to the same frame.

As illustrated in FIG. 10, each set of the time-frequency resources 311-314 has a certain size, i.e., a certain amount 252 of time-frequency resources.

It would be possible that the value of the transmission parameter is defined in accordance with the respective time-frequency resources that are allocated to the respective retransmission 902-903. More specifically, the amount 252 of time-frequency resources available for each one of the retransmissions 902-904 could be taken into account.

For example, it would be possible that the value of the transmission parameter to be used for a respective one of the retransmissions 902-904 is determined so as to fill of the respective time-frequency resources 312-313 allocated to that retransmission 902-904, i.e., use the amount 252 of available time-frequency resources.

For illustration: considering a scenario where a comparably large amount 252 (in FIG. 10, the amount of time-frequency resources corresponds to the area of the respective rectangles illustrating the time-frequency resources 311-313 in the time-frequency plot;

whereas the amount 252 has been plotted linearly in the schematic representations of FIGS. 5-9) of time-frequency resources 312 are available for the retransmission 902. Then, it would be possible to select a higher number of repetitions for one or more CBGs that are retransmitted. If only a single CBG is retransmitted, then an even higher number of repetitions can be selected if compared to a scenario where two CBGs are retransmitted (as would be apparent from a comparison of the scenario of FIG. 7 with the scenario of FIG. 9). Alternatively or additionally, it would be possible to lower the MCS. Where the MCS is lowered, this may necessitate using a smaller number of repetitions (as would be apparent from a comparison of the scenarios of FIGS. 7 and FIG. 8).

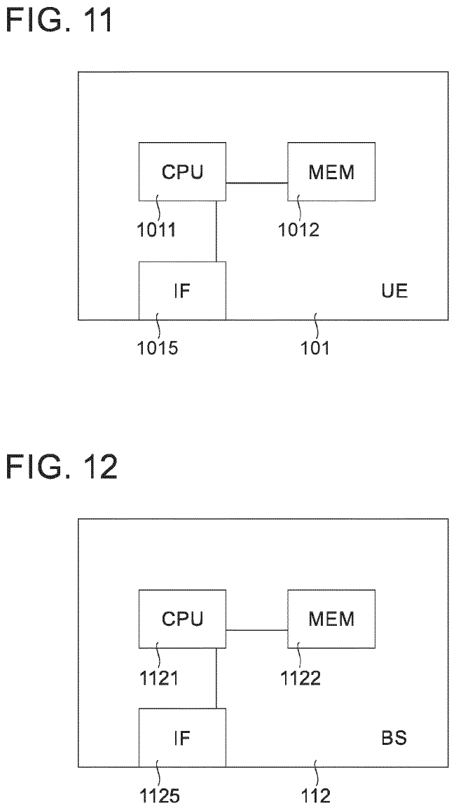

FIG. 11 illustrates aspects with respect to the UE 101. The UE 101 includes a processor 1011 and a memory 1012, the processor 1011 and the memory 1012 implementing a control circuitry. The UE 101 also includes an interface 1015. The processor 1011 can load program code from the memory 1012 and execute the program code. Upon executing the program code, the processor performs techniques as disclosed herein, e.g.: transmitting and/or receiving signals towards or from the BS 112 (communicating with the BS 112), via the interface 1015 and on the radio link 114; participating in a transmission of data, e.g., by transmitting signals encoding the data and/or by receiving signals encoding the data, e.g., by aggregating or de-aggregating the data with respect to TBs and optionally with respect to CBGs; implementing a retransmission protocol to protect transmissions of the data, the retransmission protocol triggering retransmissions of TBs or CBGs in response to respective transmission failures; implementing a dynamic link adaptation protocol, e.g., by monitoring for reference signals and/or by transmitting reference signals, by compiling a channel quality report, etc.; providing a capability to the BS, the capability being indicative of the capability of the UE to support different values of a transmission parameter for an initial transmission and at least one retransmission of data; etc.

FIG. 12 illustrates aspects with respect to the BS 112. The BS 112 includes a processor 1121 and a memory 1122, the processor 1121 and the memory 1122 implementing a control circuitry. The BS 112 also includes an interface 1125. The processor 1121 can load program code from the memory 1122 and execute the program code. Upon executing the program code, the processor performs techniques as disclosed herein, e.g.: transmitting and/or receiving signals towards or from the UE 101, via the interface 1125 and on the radio link 114; participating in a transmission of data, e.g., by transmitting signals encoding the data and/or by receiving signals encoding the data, e.g., by aggregating or de-aggregating the data with respect to TBs and optionally with respect to CBGs; implementing a retransmission protocol to protect transmissions of the data, the retransmission protocol triggering retransmissions of TBs or CBGs in response to respective transmission failures; implementing a dynamic link adaptation protocol, e.g., by monitoring for reference signals and/or by transmitting reference signals, by compiling a channel quality report, etc.; obtaining a capability from the UE, the capability being indicated for of a capability of the UE to support different values of a transmission parameter for an initial transmission and at least one retransmission of data; etc.

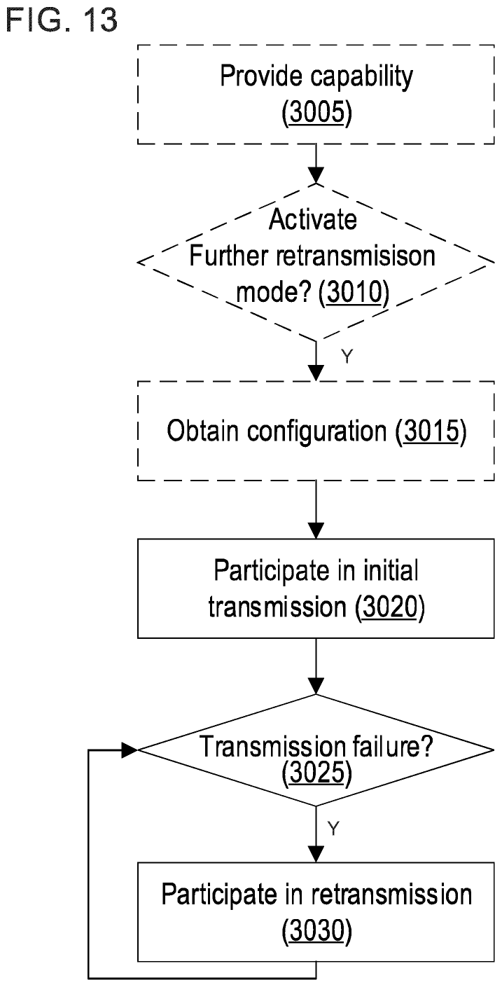

FIG. 13 is a flowchart of a method according to various examples. The method of FIG. 13 can be executed by a UE such as the UE 101. The UE can communicate with a communications NW, e.g., with a BS of a cellular NW. For instance, the method of FIG. 13 could be executed by the processor 1011 upon loading program code from the memory 1012. Optional boxes are labeled with dashed lines in FIG. 13.

At box 3005, the UE can optionally provide its capability to support dynamic adaptation of values of a transmission parameter between subsequent retransmissions of CBGs to the cellular network, specifically, to a BS. I.e., the UE can indicate whether it is capable to support a first value of the retransmission parameter used for the initial transmission of multiple CBGs to differ from one or more second values of at least one of one or more retransmissions of at least one of the CBGs.

At optional box 3010, the UE may check whether activation of a mode associated with the dynamic adjustment of values of a transmission parameter between retransmissions of CBGs is to be activated. This mode is hereinafter referred to as dynamic mode. The dynamic mode can be different from a static mode. In the static mode, the value of the respective transmission parameter is not adjusted between retransmissions of CBGs. I.e., in a static mode, the value remains static.

The dynamic mode and the static mode may be defined in the framework of a retransmission protocol.

The activation of the dynamic mode may be in accordance with the capability of the UE.

It would be optionally possible that in the static mode, the retransmissions are implemented on TB-level. I.e., instead of using CBG-based retransmissions as in the dynamic mode, the entire TB may be retransmitted.

The activation of the dynamic mode can depend on one or more trigger events. Example trigger events include a network activation. For instance, a control message may be provided by the BS that is indicative of activation or deactivation of the dynamic mode. the control message could be communicated on the PDSCH. A RRC control message can be used.

Alternatively or additionally, the activation of the dynamic mode can depend on the channel status of the radio link between the UE and the BS, as a respective trigger event. For instance, channel sounding can be implemented. One or more receive properties of reference signals can be determined and, based on such one or more receive properties, it is possible to determine the status of the radio link. For instance, a signal to interference and noise value could be determined. A Reference Signal Receive Power (RSRP) signal level could be determined. An error rate could be estimated. Depending on such and other characteristics indicative of the status of the radio link, it could be decided on whether the dynamic mode is to be activated or not. Such decision can be made autonomously at the UE, without receiving explicit signaling from the communications network.

Yet another trigger event that could be considered in box 3010 includes the application associated with the data service for which data is communicated between the UE and the BS. For instance, for certain applications, the dynamic mode may be activated; while for other applications, the static mode may be activated. For instance, the dynamic mode may be activated for such applications that have comparably challenging performance requirements, e.g., in terms of maximum allowable delay and/or data rate (cf. TAB. 1).

In case one or more trigger events are fulfilled, the UE switches from the static mode to the dynamic mode. The method then proceeds at box 3015.

At optional box 3015, the UE can obtain a configuration of the dynamic mode from the communications network. This can include receiving an explicit indication of one or more second values of a transmission parameters to be used when participating in one or more retransmissions of at least one CBG of a TB. At least one of the one or more second values can be different than a first value of the transmission parameter used in an initial transmission of the at least one CBG of the TB.

The configuration could be included in a DCI communicated on the PDCCH. For instance, the DCI could indicate which CBGs use different values of the repetitions/MCS among those that are selected for retransmissions. The dynamic mode and the static mode can use different formats of the DCI. For example, using a DCI that explicitly indicates the value of the transmission parameter to be used for the retransmission allows different CBG to have different repetitions and/or values of the MCS, etc.

In an example, a DCI would tell the UE which CBG needs repetitions and/or adaptation of the MCS value. In other embodiment, no explicit indication would be required the UE would repeat the retransmitted CBG and/or lower the MCS, e.g., to fill up predefined time-frequency resources.

Alternatively or additionally, separate DCIs may be used for the initial transmission and the retransmission; these DCIs may have different formats. This recognizes that most of the time a single transmission is suffice and so there is no need to use a different DCI format which may have a larger size or reduced fields to cater for the extra configuration.

It would also be possible that the configuration is included in a higher-layer control message, e.g., a Radio Resource Control (RRC) control message communication on the PDSCH.

Such techniques apply for both UL and DL. For UL, the configuration could tell the UE how to retransmit (e.g., which CBG and how many repetitions). For the DL direction, the configuration can tell the UE how the BS (i.e., using which value for which codeblock group) will implement the retransmission.

It is not required in all scenarios that the configuration is obtained from the communications network. In some examples, the configuration may also be fixed in the respective communication protocol. For instance, the value of the repetition count could be hardcoded, e.g., for each retransmission.

Then, the UE participates in the initial transmission, at box 3020. This can include receiving CBGs in performing a checksum check on CBG level, i.e., based on error checksums included in the CBGs. Thereby, transmission failures can be detected. At box 3025, it is checked, for each CBG included in the initial transmission, whether a respective transmission failure has occurred. For those CBGs for which a transmission failure has occurred, the UE, at box 3030 participates in respective one or more retransmissions.

Thus, as will be appreciated from the above, the initial transmission of the multiple CBGs at box 3020 uses a first value of a transmission parameter. For instance, the transmission parameter could be the repetition count or the MCS. The one or more retransmissions at iterations of box 3030 can use one or more second values of the same transmission parameter. At least one of the one or more second values can be different from the first value used at box 3020.

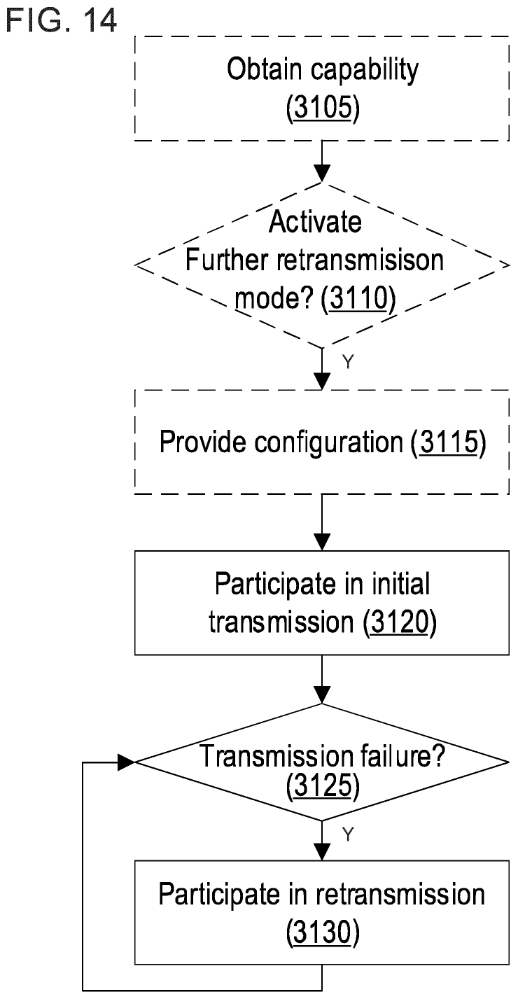

FIG. 14 is a flowchart of a method according to various examples. The method of FIG. 14 can be executed by a BS such as the BS 112. The BS can communicate with a UE. For instance, the method of FIG. 14 could be executed by the process or 1121 upon loading program code from the memory 1122. Optional boxes are labeled with dashed lines in FIG. 14.

At box 3105, the BS can optionally obtain a capability to support dynamic adaptation of values of a transmission parameter between subsequent retransmissions of CBGs from the UE. Box 3105 is interrelated with box 3005.

At box 3110, the BS may check whether activation of a mode associated with the dynamic adjustment of values of a transmission parameter between retransmissions of CBGs is to be activated. This mode is hereinafter referred to as dynamic mode. The dynamic mode can be different from a static mode. In the static mode, the value of the respective transmission parameters not adjusted between retransmission of CBGs. I.e., in the static mode, the value remains static.

Trigger events that can be considered at box 3110 have already been discussed above in connection with box 3010.

The dynamic mode may only be activated in case the capability of the UE—as obtained in box 3105—allows for such behavior.

In case the dynamic mode is activated, the method commences at box 3115. (The operation in the static mode is out of scope of the subject disclosure). At box 3115, the BS may provide a configuration of the dynamic mode to the UE. Aspects with respect to such configuration have already been explained above in connection with box 3015.

Then, the BS can participate in the initial transmission of multiple CBGs at box 3120. The BS uses a first value of a transmission parameter for the initial transmission. Box 3120 is interrelated with box 3020.

At box 3125, it is checked whether a transmission failure has occurred for one or more of the CBGs. This can be based on negative acknowledgments and positive acknowledgments received from the UE. Box 3125 thus corresponds to box 3025.

At box 3130, in case one or more transmission failures occurred, the BS participates in one or more respective retransmissions. Here, one or more second values of the transmission parameter are used, wherein at least one of the one or more second values is different from the first value used at box 3120. Box 3130 is interrelated with box 3030.

Summarizing, above techniques have been described in which retransmissions include repetitions of CBGs. Failed CBGs can be repeated one or more times within a TB. This recognizes that those CBGs that pass the checksum are not required to be retransmitted and so that resources can be used for the repetitions of the CBG that have been subject to a transmission failure. Different CBGs can be retransmitted at different repetition factors. Alternatively or additionally, retransmissions can include CBGs with lower MCS if compared to the MCS used for the initial transmission of respective CBG. Different CBGs can use different MCSs.

According to various examples, it has been described that CBG based retransmissions and associated positive/negative acknowledgment for the retransmission protocol can be dynamically enabled or disabled. In particular, a dynamic mode can be selectively enabled, wherein in the dynamic mode CBG based retransmissions are implemented and the value of a transmission parameter—e.g., repetition count and/or modulation scheme—can be dynamically adjusted between retransmissions.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

1. A method of operating a wireless communication device communicating data with a node of a communications network, the method comprising:
participating in an initial transmission of multiple code block groups of a transport block using a first value of a transmission parameter, the multiple code block groups respectively comprising a part of the data, and
participating in one or more retransmissions of at least one of the multiple code block groups using one or more second values of the transmission parameter,
wherein the first value is different than at least one of the one or more second values.

2. The method of claim 1, wherein the transmission parameter comprises at least one of a count of repetitions of the respective code block group or a count of redundancy versions for multiple repetitions of the respective code block group.

3. The method of claim 1, wherein the transmission parameter comprises a modulation and coding scheme of the respective code block group.

4. The method of claim 1, further comprising:
obtaining, from the node, an explicit or implicit indication of the one or more second values.

5. The method of claim 4, further comprising:
receiving, from the node, a downlink control information comprising scheduling information for the initial transmission and the one or more retransmissions, the scheduling information being indicative of time-frequency resources being respectively allocated to the initial transmission and the one or more retransmissions based on the transport block,
wherein the one or more second values are determined in accordance with an amount of the time-frequency resources.

6. The method of claim 5, wherein the one or more second values are determined to fill up the time-frequency resources allocated for the one or more retransmissions.

7. The method of claim 1,
wherein the initial transmission and the one or more retransmissions are in accordance with a retransmission protocol that triggers retransmissions in response to respective transmission failures determined based on error checksums,
wherein, in a first mode of the retransmission protocol, the first value is different than the one or more second values,
wherein, in a second mode of the retransmission protocol, the first value is the same as the one or more second values,
wherein the method further comprises:
switching between the first mode and the second mode in response to a predefined trigger event.

8. The method of claim 7, wherein the predefined trigger event comprises a network activation of the first mode or the second mode by the communications network.

9. The method of claim 7, wherein the predefined trigger event comprises a status of a radio link between the wireless communication device and the node.

10. The method of claim 7, wherein the predefined trigger event is based on an application associated with a data service that includes the data.

11. The method of claim 1, further comprising:
providing, to the communications network, a capability of the wireless communication device to support the first value being different than the one or more second values.

12. The method of claim 1,
wherein at least one of the one or more retransmissions includes at least two code block groups,
wherein different ones of the at least two code block groups are retransmitted in the at least one of the one or more retransmissions using different second values.

13. A method of operating a node of a communications network, the node communicating data with a wireless communication device, the method comprising:
participating in an initial transmission multiple code block groups of a transport block using a first value of a transmission parameter, the multiple code block groups respectively comprising a part of the data, and
participating in one or more retransmissions of at least one of the multiple code block groups using one or more second value of the transmission parameter,
wherein the first value is different than at least one of the one or more second values.

14. A wireless communication device for communicating data with a node of a communications network, the wireless communication device comprising a control circuitry, the control circuitry being configured to:
participate in an initial transmission of multiple code block groups of a transport block using a first value of a transmission parameter, the multiple code block groups respectively comprising a part of the data, and
participate in one or more retransmissions of at least one of the multiple code block groups using one or more second values of the transmission parameter,
wherein the first value is different than at least one of the one or more second values.

15-17. (canceled)
